(19) United States
(12) Patent Application Publication
(10) Pub. No.: US 2015/0291839 A1
(43) Pub. Date: Oct. 15, 2015

(54) Moisture-Curing Compositions, Methods and Products

(71) Applicant: Custom Building Products, Inc., Seal Beach, CA (US)

(72) Inventor: Ian Michael O'Connor, Murrieta, CA (US)

(21) Appl. No.: 14/683,247

(22) Filed: Apr. 10, 2015

Related U.S. Application Data
(60) Provisional application No. 61/978,380, filed on Apr. 11, 2014.

(51) Int. Cl. C09D 175/04; C09D 171/00; C09D 7/12; B32B 27/40; B32B 18/00; B32B 27/06; B32B 27/28; B05D 3/00; B32B 7/04

(52) U.S. Cl. CPC C09D 175/04; B05D 3/007; C09D 171/00; C09D 7/1216; B32B 7/04; B32B 18/00; B32B 27/06; B32B 27/285; B32B 27/40; B32B 2250/02; B32B 2305/72; B32B 2307/73

(57) ABSTRACT

Liquid, moisture-curing compositions comprise (a) a silane-terminated moisture-curing polymer, and (b) an inorganic adhesion promoter comprising one or more cements, pozzolan, lime, aluminum trihydroxide, one or more cement accelerators, or a mixture thereof. The composition is curable to form an impermeable barrier to liquid water, and the inorganic adhesion promoter is included in an amount effective to improve adhesion of cement mortar to a cured layer of the composition. Methods employ such compositions to form liquid water-impermeable membranes, and a variety of products employ such membranes.

### FIELD OF THE INVENTION

The present invention is directed to moisture-curing compositions which are curable to form an impermeable barrier to liquid water and exhibit improved adhesion of cement mortar to a surface of a cured layer of such a composition. The invention is further directed to methods employing such compositions and to products formed from such compositions.

### BACKGROUND OF THE INVENTION

Waterproofing membranes are widely used for waterproofing commercial, institutional and residential surfaces. In addition to the requirement that the desired impermeability to liquid water is achieved by such membranes, it is often necessary or desirable to provide one or more additional layers of material on the membrane surface. For example, in one embodiment, such membranes are used in areas which will be exposed to water, such as a shower stall, and it is desirable to apply a cement mortar and tile layer over the membrane. In such cases, it is important for the cement mortar to exhibit good adhesion to the underlying membrane surface.

One type of conventional waterproofing membrane is installed as a preformed sheet and particles of an inorganic material such as cement or the like are coated on the preformed sheet, or on a pressure-sensitive adhesive layer coated on the surface of the preformed sheet, in an attempt to increase the adhesion of additional layers to the preformed sheet membrane. Working with preformed sheets can be cumbersome in certain environments and the application of particles and adhesive is both labor intensive and an additional material cost.

Another common type of waterproofing membranes are based on latex dispersions in water. These latex dispersions are applied by coating on the desired substrate and require evaporation of the residual water before the dispersed polymer can coalescence and cure to form an irreversible waterproof barrier. Since curing and the resulting development of water resistance can be delayed or disrupted in cold and/or damp conditions which are not conducive to drying, use of latex dispersions often delays progress in a construction process.

Moisture-curing polymers have also been developed and overcome the challenges of curing in cool and damp conditions as moisture-curing polymers use ambient moisture to aid curing. However, these polymer systems have additional challenges including, importantly, poor adhesion of cement-based mortars to membranes formed from the moisture-curing polymers. Cement mortars typically exhibit low tensile bond strength to such membranes, resulting in adhesive failure between the mortar and the membrane. As it is often desirable to apply cement-based mortar and tile to a waterproof membrane, this can be a significant disadvantage of moisture-curing polymer systems.

Accordingly, there is a need for improved membranes providing an impermeable barrier to liquid water for use in the construction industry.

### SUMMARY OF THE INVENTION

It is therefore an object of the present invention to provide compositions which are curable to form an impermeable barrier to liquid water and overcome disadvantages of conventional systems.

In one embodiment, the invention is directed to liquid, moisture-curing compositions. The compositions comprise (a) a silane-terminated moisture-curing polymer, and (b) an inorganic adhesion promoter comprising one or more cements, pozzolan, lime, aluminum trihydroxide, one or more cement accelerators, or a mixture thereof. The composition is curable to form an impermeable barrier to liquid water, and the inorganic adhesion promoter is included in an amount effective to improve adhesion of cement mortar to a surface of a cured layer of the composition.

In an additional embodiment, the invention is directed to methods of forming an impermeable barrier to liquid water on a substrate. The methods comprise applying a coating of the liquid, moisture-curing composition to a substrate, and allowing the coating to cure.

In an additional embodiment, the invention is directed to a coated substrate formed by such a method and to multilayer structures including a membrane comprising a moisture-cured product of such a composition.

The compositions, methods and products of the invention are advantageous in that they allow the ease of use of a liquid for applying a waterproof membrane and cure in moist environments while providing a cured product to which one or more additional layers may be securely applied. Additional advantages of the invention will be more fully apparent and understood in view of the detailed description.

### BRIEF DESCRIPTION OF THE DRAWINGS

Certain non-limiting aspects and embodiments of the invention are illustrated in the accompanying drawings in which:

FIG. 1 is a graphical representation of shear bond strengths of a tile assembly made with a polyether-based silane-terminated polymer (STP) as described in the Example.

FIG. 2 is a graphical representation of shear bond strengths of a tile assembly made with a polyurethane-based STP as described in the Example.

### DETAILED DESCRIPTION

As used in the present specification and the appended claims, the singular forms “a,” “an” and “the” include plural referents unless the context clearly dictates otherwise. Thus, for example, reference to “a component” includes mixtures of two or more such components, even in the absence of a specific recitation of such a mixture. Additionally, ranges can be expressed herein as from “about” one particular value to “about” another particular value. When such a range is expressed, a further aspect includes from the one particular value to the other particular value. Similarly, when values are expressed as approximations, by use of “about,” it will be understood that the particular value forms a further aspect. It is also understood that each unit between two particular units are also disclosed. For example, if a range of 10 to 15 is disclosed, then 11, 12, 13, and 14 are also disclosed.

The liquid, moisture-curing compositions of the invention comprise (a) a silane-terminated moisture-curing polymer, and (b) an inorganic adhesion promoter comprising cement, pozzolan, aluminate, aluminum trihydroxide, or a mixture of two or more thereof.

Silane-terminated moisture curing polymers are well known in the art, and any such polymer or combination thereof may be employed in the compositions of the invention. The silane-terminated moisture-curing polymers possess reactive silyl groups with hydrolyzable substituents and, in the presence of atmospheric moisture, the silyl groups are able to condense with each other, even at room temperature, eliminating the hydrolyzed residues. Depending on the content of the silyl groups having hydrolyzable substituents and the structure of these silyl groups, mainly long-chain polymers (thermoplastics), relatively wide-meshed, three-dimensional networks (elastomers) or highly crosslinked systems (thermosets) are formed during this process. The polymers typically have an organic backbone which, for example, carries alkoxy silyl or acyloxy silyl groups at the ends. The organic backbone can be, for example, polyurethane, polyester, polyether, etc. Thus, common silane-terminated moisture-curing polymers for use in specific embodiments of the present invention include, but are not limited to, silane-terminated polyether polymers, silane-terminated polyurethane polymers, and silane-terminated polyester polymers, and any of these polymers, or combinations thereof, may be used in the present compositions.

In specific embodiments, the silane-terminated moisture-curing polymer comprises a silane-terminated polyether polymer having gamma (γ) linkage between the reactive silyl group and the polyether backbone, alpha (α) linkage between the reactive silyl group and the polyether backbone, or a combination of both gamma and alpha linkages between the reactive silyl group and the polyether backbone. In additional embodiments, the silane-terminated moisture-curing polymer comprises a silane-terminated polyurethane polymer. In yet additional embodiments, the silane-terminated moisture-curing polymer comprises a silane-terminated polyester polymer. Exemplary polymers are disclosed in U.S. Pat. Nos. 6,025,445, 6,410,640, 7,091,298, 6,750,309, 6,756,465, 6,864,340, 6,884,852 and 8,197,944, and U.S. Patent Publications Nos. 2013/0102738, 2012/0067520, and 2010/0055474, incorporated herein by reference. Various exemplary silane-terminated polymers are commercially available under the trade names MS Polymer® from Kaneka Americas Holding, Inc., Geniosil® from Wacker Chemie AG, Polymer ST from Evonik Industries AG, Vorasil™ from The Dow Chemical Company, and Desmoseal® from Bayer Material Science, LLC, among others.

In another specific embodiment, a combination of two or more silane-terminated moisture-curing polymers are employed to tailor the properties of the cured membrane. As will be appreciated by those skilled in the art, combinations two or more polymers with different properties can yield enhanced properties such as improved cure time, higher or lower strength, higher or lower elongation as well as other property changes.

Importantly, the compositions include an inorganic adhesion promoter comprising one or more cements, pozzolan, lime, aluminum trihydroxide, one or more cement accelerators, or a mixture thereof. This adhesion promoter promotes adhesion of a cement mortar layer to a cured layer of the composition. Various cements are suitable for use in the compositions, including, but not limited to Portland cement, or more specifically, ordinary Portland cement (OPC), and blends of Portland cement with other materials. Exemplary cements also include calcium aluminate cements, calcium sulfoaluminate cements, calcium sulfate anhydrite, and calcium sulfate hemihydrates. A pozzolan is a siliceous, or siliceous and aluminous, material which, in itself, possesses little or no cementitious value but which will, in finely divided form and in the presence of water, react chemically with calcium hydroxide at ordinary temperature to form compounds possessing cementitious properties. Both natural and synthetic materials which show the described pozzolanic activity may be used. Natural pozzolans are typically of volcanic origin, and volcanic ashes and pumices largely composed of volcanic glass are commonly used, as are deposits in which the volcanic glass has been altered to zeolites by interaction with alkaline waters. Synthetic pozzolans can be produced by thermal activation of kaolin-clays to obtain metakaolin or can be obtained as waste or by-products from high-temperature process such as fly ashes from coal-fired electricity production, silica fume from silicon smelting, and burned organic matter residues rich in silica such as rice husk ash. Cement accelerators include, but are not limited to, calcium formate, calcium chloride, calcium nitrite, and sodium chloride, among others known to those skilled in the art. The composition is curable to form an impermeable barrier to liquid water and the inorganic adhesion promoter is included in an amount effective to improve adhesion of cement mortar to a cured layer of the composition.

The compositions may include the indicated components in a range of amounts. The silane-terminated moisture-curing polymer is included in an amount sufficient to provide a continuous liquid water-impermeable membrane upon curing of the composition. In specific embodiments, the compositions comprise from about 20 to about 60 wt % of the silane-terminated moisture-curing polymer, or, more specifically, from about 25 to about 50 wt % of the silane-terminated moisture-curing polymer. As noted, the compositions include the inorganic adhesion promoter in an amount effective to improve adhesion of cement mortar to a surface of a cured layer of the composition. In specific embodiments, the compositions include from about 0.5 to about 30 wt % of the inorganic adhesion promoter, or, more specifically, about 1 to about 20 wt % of the from inorganic adhesion promoter. In further embodiments, the compositions include from about 5 to about 10 wt % of the inorganic adhesion promoter. The balance of the compositions may comprise one or more convention additives as described.

The compositions may further comprise one or more additives, including, but not limited to, organic silane compound adhesion promoters, one or more of catalysts, fillers, water scavengers, plasticizers, photosensitizers, pigments, stabilizers, antioxidants, reactive diluents, drying agents, UV stabilizers, anti-ageing agents, rheological auxiliaries, fungicides, flame retardants, and other conventional additives. Such conventional additives are employed in amounts conventionally known for achieving their desired effect.

More specifically, depending on the specific silane-terminated polymer which is employed, the compositions may also comprise an organic silane compound adhesion promoter. Such compounds are known in the art for use together with silane-terminated moisture-curing polymers. In specific embodiments, the organic silane compound comprises an amino silane, a glycidoxy silane, or an isocyanato silane. Suitable examples include, but are not limited to, 3-aminopropyltriethoxysilane, 3-aminopropyltrimethoxysilane, 3-aminopropylmethyldiethoxy-silane, 3-aminopropylmethyldimethoxysilane, methylaminopropyltrimethoxysilane, 1,3,5-tris(trimethylsilylpropyl)isocyanurate, 3-glycidoxypropyltrimethoxysilane, 3-glycidoxypropyl-ethyldimethoxysilane, 2-glycidoxyethyltrimethoxysilane, 2-cyanoethyltrimethoxysilane, 3-cyanopropyltriethoxysilane, isocyanatopropyltriethoxysilane, isocyanatopropyltrimethoxysilane, or mixtures of two or more thereof.

In specific embodiments, the compositions comprise from about 0.1 to about 10 wt %, or, more specifically, from about 0.5 to about 5 wt %, of an organic silane compound adhesion promoter. In more specific embodiments, the compositions comprise, from about 20 to about 60 wt % of the silane-terminated moisture-curing polymer, from about 0.5 to about 30 wt % of the inorganic adhesion promoter, and from about 0.1 to about 10 wt % of an organic silane compound adhesion promoter.

Depending on the specific silane-terminated polymer which is employed, a catalyst to initiate or aid crosslinking and curing of the composition may be desired. Conventional catalysts suitable for the compositions include organometallic compounds. In more specific embodiments, the catalyst comprises an organotin or organotitanium compound, examples of which include, but not limited to, the 1,3-dicarbonyl compounds of di- or tetravalent tin, for example the acetylacetonates such as di(n-butyl)tin(IV) di(acetylacetonate), di(n-octyl)tin(IV) di(acetylacetonate), and (n-octyl)(n-butyl)tin(IV) di(acetylacetonate); dialkyltin(IV) dicarboxylates, for example di-n-butyltin dilaurate, di-n-butyltin maleate, di-n-butyltin diacetate, and di-n-octyltin diacetate; or the corresponding dialkoxylates, for example, di-n-butyltin dimethoxide; tin(II) carboxylates such as tin(II) octoate and tin(II) phenolate; and alkyl titanates such as tetraisopropyl titanate and tetrabutyl titanate. In further embodiments, the compositions further comprise a curing catalyst in an amount of from about 0.01 to about 5 wt %, or, more specifically, from about 0.05 to about 2 wt %.

Reaction of the silane-terminated polymer can also be accelerated through the use of highly reactive amino alkyl silanes, an example of which includes N-(2-aminoethyl)-3-aminopropyltrimethoxysilane, and such compounds can therefore be employed in the compositions of the invention, alone or in combination with an organometallic catalyst compound. In a specific embodiment, an amino alkyl silane accelerator is used together with an organotin catalyst. In specific embodiments, the compositions include from about 0.01 to about 5 wt %, or, more specifically, from about 0.05 to about 2 wt % of such an amino alkyl silane accelerator.

Exemplary fillers to include in the compositions include, but are not limited to, silica, carbon black, metal oxides, for example, titanium dioxide, ferric oxide, aluminum oxide, and zinc oxide, quartz, calcium carbonate or limestone, zirconium silicate, gypsum, silicon nitride, boron nitride, barium sulfate, zeolite, glass and plastic powder, and mixtures of two or more thereof. In specific embodiments, the compositions further comprise one or more fillers in an amount of from about 20 to about 60 wt %, or, more specifically, from about 30 to about 60 wt %.

The compositions may include a water scavenger which typically is selected to balance with the catalyst (when employed) to ensure a combination of good shelf life and rapid curing upon exposure to moisture. Typical water scavengers include, but are not limited to, vinyltrimethoxysilane, vinyltripropenoxysilane, carbamatomethylsilanes, tetraethoxysilane, hexamethyldisilanzane, acetoxysilanes, or isocyanates. In specific embodiments, a water scavenger is included in the compositions in an amount of from about 0.1 to about 10 wt %, or, more specifically, from about 1 to about 10 wt %.

In a specific embodiment, a combination of catalyst, accelerator and scavenger is employed in order to tailor the curing properties, for example, to balance early skinning and rapid full curing of the composition to form a membrane.

A plasticizer and/or a solvent or diluent may be used to reduce the viscosity of the compositions and thus facilitate their processability. A plasticizer can, in addition, improve flexibility and/or extensibility of the cured compositions. In specific embodiments, the plasticizer is a fatty acid ester, a dicarboxylic acid ester, an ester of OH group-carrying or epoxidized fatty acids, a fat, a glycolic acid ester, a phthalic acid ester, a benzoic acid ester, a phosphoric acid ester, a sulfonic acid ester, a trimellitic acid ester, an epoxidized plasticizer, a polyether, a polystyrene, a hydrocarbon or a chlorinated paraffin, or a mixture of two or more thereof. Typical solvents include, but are not limited to, glycol ethers, including ethylene glycol monobutyl ether and/or ethylene glycol dibutyl ether, mineral spirits, and polydimethyl-cyclosiloxane solvents, including D4 solvent and/or D5 solvent. In specific embodiments, the compositions include from about 0.1 to about 10 wt % plasticizer and/or from about 1 to about 10 wt % solvent.

The viscosity of the compositions may be adjusted as desired to provide advantageous handling properties, as is known in the art. In one embodiment, the viscosity of the composition may be in the range of about 14 kcP-22 kcP, measured using a Brookfield Spindle 07 at 10 RPM.

Various specific combinations of silane-terminated moisture-curing polymer and inorganic adhesion promoter, and optionally including one or more additional additives, may be formulated based on the above teachings. In specific embodiments, the compositions comprise from about 20 to about 60 wt % of a silane-terminated polyether polymer or a silane-terminated polyurethane polymer, and from about 1 to about 20 wt % of Portland cement as the inorganic adhesion promoter. In more specific embodiments, such compositions further comprise a filler. In even more specific embodiments, such compositions further comprise limestone as a filler, and, even more specifically, from about 30 to about 60 wt % limestone. In further embodiments, the compositions further include an amino silane compound adhesion promoter

The composition is curable to form an impermeable barrier to liquid water. Generally, the composition is applied to a substrate and exposed to moisture, typically ambient humidity. An ambient humidity of at least 30% is preferred to ensure relatively fast curing of the composition. The composition may be applied by any technique known in the art and, in one embodiment, is applied as a coating by rolling, brushing or spraying. Thus, the composition desirably has a rheology which allows such applications. The composition may be applied to any type of substrate, including, but not limited to, metal, polymer, ceramic, tile, glass, marble, concrete, granite, sandstone, limestone or wood. In a specific embodiment, the composition is applied as a coating layer over a presloped “mud bed”, i.e., a hand troweled surface formed of a cement/aggregate system. Upon curing, the composition forms a cured membrane which is impermeable to liquid water. Suitably, a cement mortar layer may be applied to the cured membrane. In a specific embodiment, thinset mortar and a tile layer are applied to the cured membrane. The cement mortar surprisingly exhibits improved adhesion to the cured membrane as compared with a similar membrane which does not include the inorganic adhesion promoter.

The following Example demonstrates specific embodiments of the invention for illustrative purposes only and does not limit the invention defined by the claims in any respect.

### Example

Exemplary compositions for the waterproof membrane are prepared with the following steps: 1) mix the silane terminated polymer(s), water scavenger and any diluents (if used) to homogeneity using a high shear mixing blade (cowels blade) at 1000 rpm; 2) blend in the aminosilane adhesion promoter and antioxidant; 3) premix the filler, pigment and adhesion promoter and blend into the liquid at 1400 rpm until homogeneous; reduce speed to 300 rpm and mix in the rheology modifier until homogeneous; 4) dose catalysts and accelerators and mix until completely blended. This process is exemplary only and one of ordinary skill in the art will envision additional processes for forming the compositions without departing from the invention.

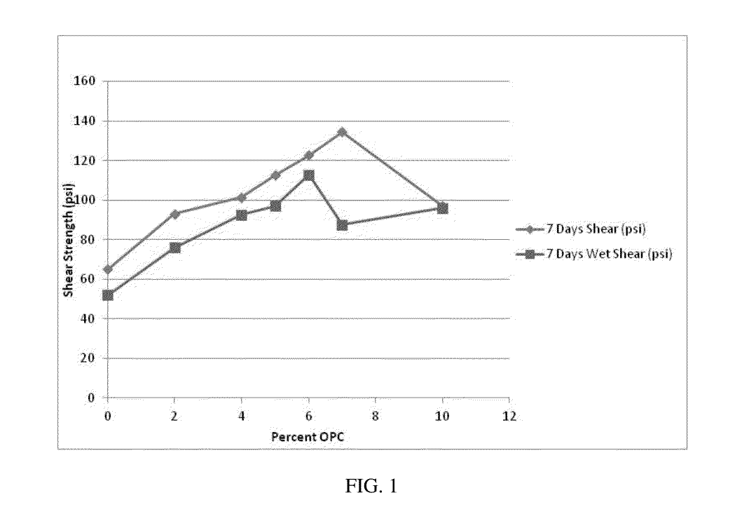

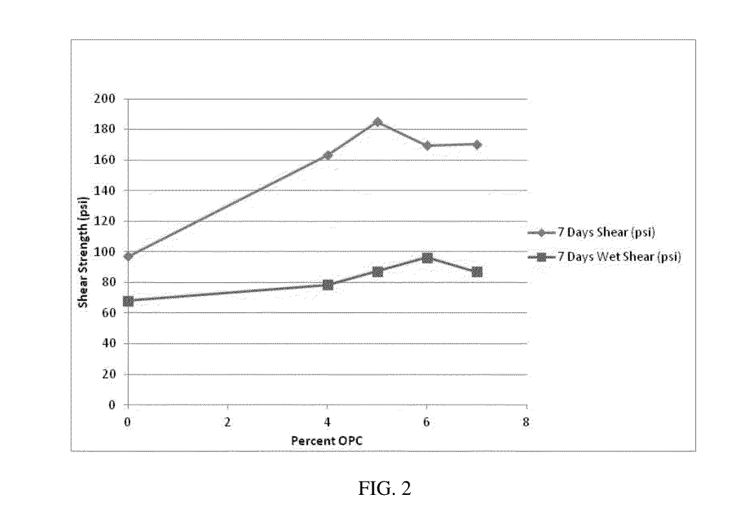

Compositions according to the invention and comprising about 40 wt % silane-terminated moisture-curing polymer, limestone filler and from about 2 to 10 wt % ordinary Portland cement (OPC) as the inorganic adhesion promoter were applied to substrates by roller coating, and the compositions were moisture cured by exposure to ambient humidity. For comparison purposes, a comparative composition was applied to the same type of substrate and moisture cured by exposure to ambient humidity. The comparative composition was identical to the inventive compositions except that no OPC was included. In each composition, the OPC (where employed) and limestone filler combined for about 45 wt % of the composition. The balance of the compositions comprised organic silane compound adhesion promoter, rheology modifiers, moisture scavenger, catalyst and accelerator. Once the respective coatings were cured to form liquid water-impermeable membranes, ceramic tile was installed over the membrane using a cement-based thinset mortar and allowed to cure. The 7 day shear bond strength and the 7 day wet shear bond strength (ASTM C482) of the tiled assemblies are set forth in FIGS. 1 and 2 for membranes based on polyether- and polyurethane-based STP membranes, respectively. The results show that the OPC, as the inorganic adhesion promoter, surprisingly provided a significant improvement in the bond strengths as compared with the comparative composition (0% OPC).

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification, embodiments and examples be considered as exemplary only, with a true scope and spirit of the invention being indicated by the following claims.

What is claimed is:

1. A liquid, moisture-curing composition comprising (a) a silane-terminated moisture-curing polymer, and (b) an inorganic adhesion promoter comprising one or more cements, pozzolan, lime, aluminum trihydroxide, one or more cement accelerators, or a mixture thereof, wherein the composition is curable to form an impermeable barrier to liquid water and the inorganic adhesion promoter is included in an amount effective to improve adhesion of cement mortar to a surface of a cured layer of the composition.

2. The composition of claim 1, wherein the silane-terminated moisture-curing polymer comprises a silane-terminated polyether polymer, a silane-terminated polyurethane polymer, or a silane-terminated polyester polymer.

3. The composition of claim 1, wherein the inorganic adhesion promoter comprises a cement.

4. The composition of claim 3, wherein the cement comprises ordinary Portland cement.

5. The composition of claim 1, comprising, from about 20 to about 60 wt % of the silane-terminated moisture-curing polymer, and from about 0.5 to about 30 wt % of the inorganic adhesion promoter.

6. The composition of claim 1, comprising, from about 25 to about 50 wt % of the silane-terminated moisture-curing polymer, and from about 1 to about 20 wt % of the inorganic adhesion promoter.

7. The composition of claim 1, wherein the composition further comprises an organic silane compound adhesion promoter.

8. The composition of claim 7, wherein the organic silane compound adhesion promoter comprises an amino silane compound.

9. The composition of claim 1, further comprising one or more fillers in an amount of from about 20 to about 60 wt %.

10. The composition of claim 9, wherein the filler comprises silica, carbon black, titanium dioxide, ferric oxide, aluminum oxide, zinc oxide, quartz, limestone, zirconium silicate, gypsum, silicon nitride, boron nitride, barium sulfate, zeolite, glass, plastic powder, or a mixture of two or more thereof.

11. The composition of claim 1, further comprising a curing catalyst.

12. The composition of claim 1, comprising from about 25 to about 50 wt % of a silane-terminated polyether polymer or a silane-terminated polyurethane polymer, from about 1 to about 20 wt % ordinary Portland cement as the inorganic adhesion promoter, and from about 30 to about 60 wt % of a filler comprising limestone.

13. A method of forming an impermeable barrier to liquid water on a substrate, comprising applying a coating of the composition of claim 1 to a substrate, and allowing the coating to cure.

14. The method of claim 13, wherein the substrate is formed of metal, polymer, ceramic, tile, glass, marble, concrete, granite, sandstone, limestone or wood.

15. A coated substrate formed by the method of claim 13.

16. A coated substrate formed by the method of claim 14.

17. A multilayer structure, comprising (i) a substrate, (ii) a liquid water-impermeable membrane applied to the substrate and comprising a moisture-cured product of a composition comprising (a) a silane-terminated moisture-curing polymer, and (b) an inorganic adhesion promoter comprising one or more cements, pozzolan, lime, aluminum trihydroxide, one or more cement accelerators, or a mixture thereof, wherein the inorganic adhesion promoter is included in the composition in an amount effective to improve adhesion of cement mortar to a cured layer of the composition, and (iii) a cement mortar layer adhered to the membrane.

18. The multilayer structure of claim 17, further comprising tile adhered to the cement mortar layer.

19. The multilayer structure of claim 17, wherein the inorganic adhesion promoter comprises a cement.

20. The multilayer structure of claim 17, wherein the liquid water-impermeable membrane applied to the substrate comprises a moisture-cured product of a composition comprising from about 25 to about 50 wt % of a silane-terminated polyether polymer or a silane-terminated polyurethane polymer, from about 1 to about 20 wt % ordinary Portland cement as the inorganic adhesion promoter, and from about 30 to about 60 wt % of a filler comprising limestone.
